(19) United States
(12) Patent Application Publication
(10) Pub. No.: US 2006/0250541 A1
(43) Pub. Date: Nov. 9, 2006

(54) Illumination system

(76) Inventor: Hubertina Petronella Maria Huck, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/562,874

(22) PCT Filed: Jun. 29, 2004
(86) PCT No.: PCT/IB04/51046

§ 371 Date: Dec. 29, 2005

(30) Foreign Application Priority Data
Jul. 1, 2003 (EP) 03101964.9

(51) Int. Cl. G02F 1/1335

(52) U.S. Cl. 349/61

(57) ABSTRACT

An illumination system (8) comprises an optical waveguide (18) which is made from optically transparent components and has four end faces (10, 10′). A light source (12) whose light is coupled into the optical waveguide (18) via one of the end faces (10) is situated opposite this end face (10). The optical waveguide (18) has a light guide (30). A birefringent layer (36) comprising liquid crystals is provided on the light guide (30) at an exit surface side thereof. A first electrode (40) and a second electrode (44) both have electrical contact with the birefringent layer (36) and are connected to a voltage generator (46). By varying the voltage applied between the electrodes (40, 44), the birefringent properties of the birefringent layer (36) comprising the liquid crystals may be varied to control the direction of light coupled out via the exit surface (16).

### FIELD OF THE INVENTION

The present invention relates to an illumination system comprising an optical waveguide that is optically transparent and has an exit surface and a plurality of end faces, opposite to at least one of which a light source is situated whose light is to be coupled into the optical waveguide at said at least one end face, the optical waveguide having polarizing means integrated therein for polarizing the light emitted by the light source.

The invention further relates to a method of manufacturing polarizing means in an optical waveguide that is optically transparent and has an exit surface and a plurality of end faces, opposite to at least one of which a light source is adapted to be situated whose light is to be coupled into the optical waveguide at said at least one end face, the polarizing means being adapted to polarize the light emitted by the light source.

The invention also relates to a method of controlling the direction of coupling out polarized light from an illumination system comprising an optical waveguide that is optically transparent and has an exit surface and a plurality of end faces, opposite to at least one of which a light source is situated whose light is to be coupled into the optical waveguide at said at least one end face, the optical waveguide having polarizing means integrated therein for polarizing the light emitted by the light source.

### BACKGROUND OF THE INVENTION

Illumination with unpolarized or polarized light is a widespread technology. One example is illumination of LCD displays that are frequently used for displaying information to a user, referred to as the viewer hereinafter, of a mobile phone, a PDA, or another electronic device. An LCD display is preferably illuminated with polarized light. The illumination may be implemented either as a backlight illumination where the light is emitted towards the viewer via the display panel or as a frontlight illumination where the light is emitted towards the display panel and is then reflected back towards the viewer. The international application WO 01/51849 describes a display device comprising an optical waveguide for providing illumination of a display panel. The optical waveguide is provided with grooves that are filled with a birefringent material. The birefringent material in the grooves splits light coming in from the side into two light beams having mutually opposed polarizations. The grooves of the optical waveguide are thus filled with an anisotropic uniaxial material, for example nematic liquid crystalline material, to achieve the coupling-out of polarized light of a desired polarization towards the display panel that is to be illuminated. Illumination with polarized light may also be used for room lighting. In the prior art illumination systems, such as that described in WO 01/51849, the direction of the polarized light coupled out is fixed and cannot be controlled.

### SUMMARY OF THE INVENTION

An object of the present invention is to provide an illumination system which decreases or eliminates the drawbacks of the prior art and thus provides an illumination system in which the direction of the polarized light coupled out can be controlled. This object is achieved with an illumination system according to the preamble and characterized in that the polarizing means comprises:

a light guide, which is made of an optically transparent material and is adapted to receive said light coupled into the optical waveguide at said at least one end face,

a birefringent layer comprising liquid crystals provided on the light guide at the exit surface side thereof, and

a first electrode and a second electrode both having electrical contact with the birefringent layer and being adapted to be connected to a voltage generator by which the voltage applied between the electrodes and thereby the birefringent properties of the birefringent layer comprising the liquid crystals may be varied to control the direction of light coupled out via the exit surface.

An advantage of the present invention is that the direction of the light coupled out can be controlled and varied. The illumination provided by the illumination system can thus be varied in response to the ambient conditions, the nature of the object or activity that is to be illuminated, and the preferences of the user. Liquid crystals are well known from LCD display applications and are readily available. The control of the birefringent properties by varying the voltage is a simple and robust process also well known from LCD applications. Thus the illumination system is based on common manufacturing methods, cheap to manufacture, and easy to handle.

The measure according to claim 2 has the advantage of providing a coupling-out of the light at a greater angle from the exit surface, and even normal to the exit surface. Thus the microstructures render it possible to control the coupling-out of light in directions ranging from almost normal to the exit surface, when e.g. a comparatively high voltage is applied, to a great angle to the normal of the exit surface, when e.g. a low voltage or no voltage is applied.

The measure according to claim 3 has the advantage of providing an efficient way of coupling out in a direction substantially normal to the exit surface.

The measure according to claim 4 has the advantage of keeping the liquid crystals, being in a liquid crystalline state, of the birefringent layer confined on the light guide. Thus the illumination system may be oriented in any direction without the risk of leakage. The protective cover also protects the birefringent layer from damage and contamination.

The measure according to claim 5 has the advantage that the face of the protective cover facing the birefringent layer is generally plane and is thus suitable for the attachment of at least one of the electrodes.

The measure according to claim 6 has the extra advantage of avoiding the need for placement of electrodes on that surface of the light guide which faces the birefringent layer. Said surface of the light guide may be provided with microstructures, e.g. grooves, which makes the placement of electrodes thereon difficult. The placement of both electrodes in the cover, on the face thereof facing the birefringent layer, makes manufacturing easier and increases the freedom in choosing the shape and placement of microstructures on the light guide.

The measure according to claim 7 has the advantage of providing an increased freedom in the placement of electrodes in the cover and/or on the light guide.

The measure according to claim 8 has the advantage of providing the possibility of addressing only part of the illumination system. Thus it is possible to use separate voltage generators or switches to apply a voltage to only some of the electrodes and thus obtain a coupling-out of light at a great angle from part of the illumination system only.

The measure according to claim 9 has the advantage of enabling the placement of electrodes in the path of the coupled light out without decreasing the intensity of said light.

A further object of the invention is to provide a method of manufacturing controllable polarizing means in an optical waveguide for use in an illumination system in which the direction of the polarized light coupled out can be controlled.

This object is achieved with a method according to the preamble and characterized by the steps of:

forming a light guide of an optically transparent material for receiving said light coupled into the optical waveguide at said at least one end face,

forming a birefringent layer comprising liquid crystals on the light guide at the exit surface side thereof, and

connecting a first electrode and a second electrode to the birefringent layer comprising the liquid crystals for controlling the direction of polarized light coupled out via the exit surface by the polarizing means.

An advantage of this method of manufacturing a polarizing means is that components well known from other technical fields, such as that of LCDs, may be used. The polarizing means thus manufactured is robust, comparably cheap with respect to manufacturing costs, and provides an easily controllable direction of the light coupled out.

The measure according to claim 11 has the advantage of providing a simple and efficient way of providing one or both electrodes in the illumination system since that face of the protective cover which faces the birefringent layer is generally flat and well suited for the attachment of one or several electrodes.

A further object of the invention is to provide a method of controlling the direction of the polarized light coupled out from an illumination system.

This object is achieved with a method according to the preamble and characterized by the use of a polarizing means comprising:

a light guide which is made of an optically transparent material and is adapted to receive said light coupled into the optical waveguide at said at least one end face,

a birefringent layer comprising liquid crystals provided on the light guide at the exit surface side thereof, and

a first electrode and a second electrode both having electrical contact with the birefringent layer, wherein

a voltage is applied between the first and the second electrode, which voltage provides the desired direction of the polarized light coupled out via the exit surface.

An advantage of this method is that the direction of the light coupled out may be controlled with simple means, e.g. a voltage generator, and that, except for possibly the voltage generator itself, no mechanical means are required for controlling the direction of the light coupled out. Thus the control of the direction of the light coupled out is easy to handle by the end user or viewer and is robust owing to the absence of mechanical components. The inventive method of controlling the direction of light coupled out is thus suitable for several areas of illumination where easy handling and robust operation are desired.

The measure according to claim 13 has the advantage of providing the possibility of a direct lighting, i.e. light coupled out normal to the exit surface or at a small angle to the normal of the exit surface, and a diffuse lighting, i.e. light coupled out at great angles to the normal of the exit surface, simultaneously and from the same illumination system. A user can control the illumination system and choose which regions thereof that should provide which type of lighting.

These and other aspects of the invention will be apparent from and elucidated with reference to the embodiments described hereinafter.

### BRIEF DESCRIPTION OF THE DRAWINGS

The invention will now be described in more detail and with reference to the appended drawings, in which:

FIG. 1 is a cross-section and shows a reflective display device equipped with an illumination system according to the invention.

FIG. 2 is a cross-section and shows, in greater detail, an illumination system shown in FIG. 1.

FIG. 3 is a cross-section and shows the illumination system of FIG. 2 when a higher voltage is applied between a first and a second electrode of the illumination system.

FIG. 4 is a cross-section and shows an examination room equipped with an illumination system according to another embodiment of the invention.

FIG. 5 is a cross-section and shows an alternative embodiment of the invention.

FIG. 6 is a plan view and shows a cover glass shown in FIG. 5 as seen in the direction of the arrow VI.

FIG. 7 is a plan view and shows a cover glass that is used in yet another alternative embodiment of the invention.

FIG. 8 is a cross-section and shows still another alternative embodiment of the invention.

The Figures are diagrammatic and not to scale. Corresponding components generally have the same reference numerals.

### DESCRIPTION OF PREFERRED EMBODIMENTS

In the description below, “birefringent” means that a transparent object has one refractive index, the ordinary refractive index, for light of a first polarization and another refractive index, the extraordinary refractive index, for light of a second polarization opposed to said first polarization. Materials that show birefringence can be called “anisotropic”. A material that has the same refractive index regardless of the polarization of the light is called “isotropic”.

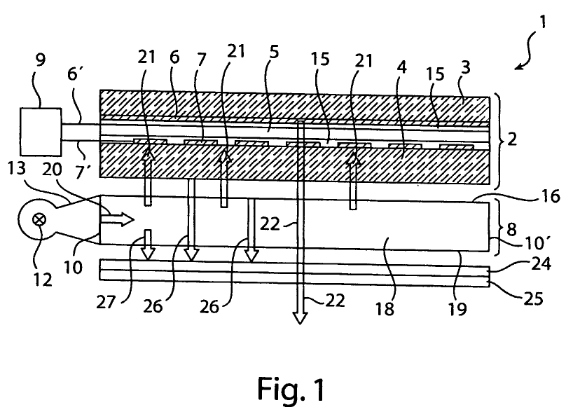

A display device 1 shown diagrammatically in FIG. 1 comprises an image display panel 2 and an illumination system 8 located between a viewer (not shown) and the display panel 2 and thus providing a frontlight illumination of the display panel 2.

The image display panel 2 comprises a liquid crystalline material 5 between two substrates 3, 4, based on the twisted nematic (TN), the supertwisted nematic (STN), or the ferroelectric effect so as to modulate the direction of polarization of incident light. The image display panel 2 comprises, for example, a matrix of pixels for which light-reflecting picture electrodes 6 are provided on the substrate 3. The substrate 4 is light-transmissive and has one or more light-transmissive electrodes 7 of, for example, ITO (Indium-Tin Oxide). The picture electrodes are provided with electric voltages via connection wires 6′, 7′ which are provided with drive voltages by means of a drive unit 9. The substrates and electrodes are coated with orientation layers 15 in known manner.

The illumination system 8 comprises an optical waveguide 18 which is made from optically transparent components and has four end faces 10, 10′. A light source 12 whose light is coupled into the optical waveguide 18 via one of the end faces, for example 10, is situated opposite this end face. The light source 12 may be, for example, a tubular fluorescent lamp. The light source may alternatively be constituted by one or more light-emitting diodes (LED), notably in flat panel display devices having small image display panels such as, for example, portable telephones. Moreover, the light source 12 may be detachable.

The exit surface or exit face 16 of the optical waveguide 18 faces the image display panel 2. Each end face 10′ of the transparent plate into which light is not coupled in may be provided with a reflector. In this way, light which is not coupled out at the exit face 16, and consequently propagates through the optical waveguide 18 and arrives at an end face 10′, is thus prevented from leaving the optical waveguide 18 via this end face 10′.

To prevent light from leaving the optical waveguide 18 without contributing to the light output of the illumination system 8, light of the light source 12 is preferably coupled into the optical waveguide 18 via coupling means 13.

A light beam 20 from the light source 12 is converted into polarized light in a manner to be described below, so that mainly light of one polarization is deflected towards the reflective image display panel 2 (beams 21) and, depending on the state of a pixel, reflected (beam 22) with the same or the opposite polarity.

After reflection at the pixel, the light of the opposite polarization is converted in a phase plate or retarder 24 into linearly polarized light and reaches a polarizer 25 with such a direction of the transmission axis in this embodiment that the reflected light is absorbed. Similarly, polarized light of the same polarization is passed by the polarizer 25.

Stray light, which is reflected at internal surfaces (for example, the surface 16), has a polarization which is opposed to that of the beam 22 and is also converted by the retarder 24 into linearly polarized light which is absorbed by the polarizer 25 (beams 26). Parasitic light generated in the optical waveguide 18 by internal reflection is also absorbed by the polarizer 25 (beam 27).

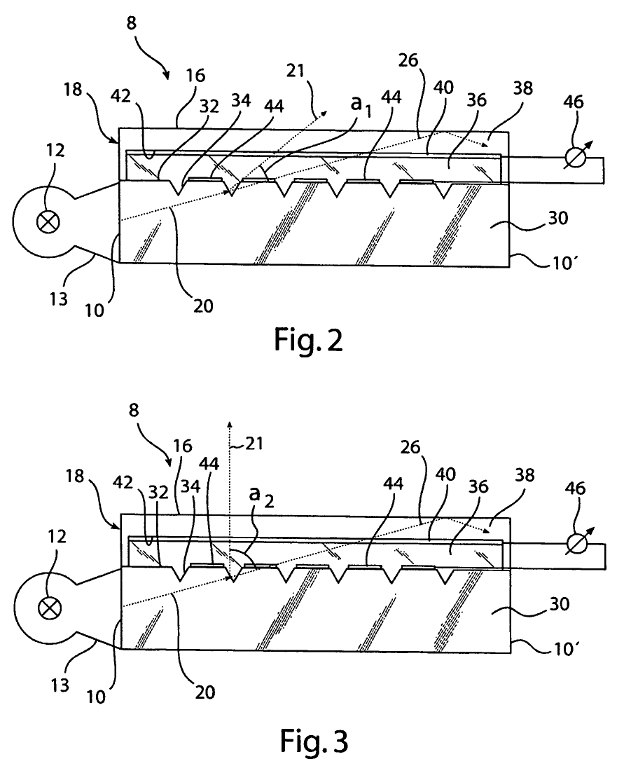

FIG. 2 is a sectional side view of the illumination system 8 comprising the optical waveguide 18. The optical waveguide 18 has a flat light guide 30 which is a rectangular parallelepiped made from a material having good optical properties, such as PMMA (polymethyl methacrylate). The dimensions of the light guide 30 are adapted to fit the actual application but could, as a typical example, be 60 mm by 60 mm with a thickness of 1 mm for a PDA (Personal Digital Assistant) display. The light guide 30 has a surface 32 which faces the display panel 2 and is thus located on the exit surface side of the light guide 30. The surface 32 is provided with microstructures for coupling out in the form of triangular grooves 34 that extend in a direction parallel to the end face 10 where light is coupled in from the light source 12. A birefringent layer 36 is applied on said surface 32 of the light guide 30 which faces the display panel 2. The birefringent layer 36 comprises non-polymerizable switchable liquid crystals in a liquid matrix. The liquid crystals are preferably of the type used in Liquid Crystal Displays (LCDs). Thus the liquid crystals change their orientation when a voltage is applied. The change of orientation of the liquid crystals also affect the anisotropy direction of the birefringent layer comprising the liquid crystals. Thus the difference between the ordinary refractive index and the extraordinary refractive index of the birefringent layer varies with the voltage applied. Preferably, the ordinary refractive index of the birefringent layer 36 is similar to the refractive index of the (isotropic) light guide 30. The birefringent layer 36 can be considered to be a liquid. Thus the grooves 34 become filled with the liquid matrix comprising the liquid crystals.

A transparent protective cover in the form of a protective cover glass 38 is applied on the light guide 30 to keep the liquid birefringent 36 layer in place on the surface 32. A first electrode 40 is attached to that surface 42 of the cover glass 38 that faces the birefringent layer 36. The first electrode 40 is thus in contact with the birefringent layer 36. The first electrode is preferably made of ITO (Indium-Tin Oxide), which is a transparent, conductive material. A second electrode 44 is attached to the surface 32 of the light guide 30. Thus the second electrode 44 is also in contact with the birefringent layer 36. The second electrode 44, which may be formed of the same material, ITO, as the first electrode 40, is formed of stripes, which are in electrical contact (not shown) with each other, so as to provide openings for the grooves 34. The first electrode 40 and the second electrode 44 are connected to a voltage generator 46. The surface 32 and the face 42 may be covered with orientation layers (not shown in FIG. 2) which are known from LCD technology for providing a proper orientation of the liquid crystals.

The situation shown in FIG. 2 is with a low voltage (typically 0-2 V, depending on the type of liquid crystals) applied between the first electrode 40 and the second electrode 44 by the voltage generator 46. At such a low voltage, the liquid crystals, which are elongated structures, of the birefringent layer 36 are mainly orientated such that their respective longitudinal axes are aligned perpendicular to the direction of the grooves 34. With such an orientation of the liquid crystals, the extraordinary refractive index of the birefringent layer is almost the same as the ordinary refractive index of the birefringent layer. A beam 20 of unpolarized light is emitted from the light source 12. When the beam 20 enters the groove 34 filled with birefringent material, i.e. the liquid crystals in their liquid matrix, with an extraordinary refractive index, which is slightly higher than the refractive index of the light guide 30, the beam 20 is split up into a beam 21 of s-polarized light (i.e. the plane of the light wave is coincident with the plane of the paper) and a beam 26 of p-polarized light (i.e. the plane of the light wave is perpendicular to the plane of the paper). As is clear from FIG. 2, the beam 26 of a p-polarized light is not deflected at all since it is subject to the ordinary refractive index of the birefringent material in the groove 34, the ordinary refractive index of the birefringent material being substantially the same as the refractive index of the light guide 30. The beam 21 of s-polarized light, however, is deflected since it is subjected to the extraordinary refractive index of the birefringent material in the groove 34, said extraordinary refractive index being higher than the refractive index of the light guide 30. As is shown in FIG. 2, the beam 21 (s-polarized light) is coupled out at a rather small angle α1 to the beam 26 (p-polarized light). This is due to the fact that the extraordinary refractive index of the birefringent layer is not much higher than the ordinary refractive index. The beam 21 then enters the display panel 2 as described above. The beam 26 is internally fully reflected inside the optical waveguide 18 and may finally be coupled out from the optical waveguide 18 at a small angle, such that it does not reach the display panel 2, or it may leave the optical waveguide 18 via one of the end faces 10, 10′, where it can be effectively recycled by a diffuse end reflector (not shown in FIG. 2).

As shown in FIG. 2, the light from the light source 12 is coupled into the light guide 30 at a comparatively small angle to the plane of the light guide 30, while the s-polarized light is coupled out at a comparatively great angle to the plane of the light guide 30. The small angle of the light beam 20 from the light source 12 prevents light of the unwanted polarity, i.e. the p-polarized light, from being coupled out via the exit face 16 and instead reflects it from that face 16.

FIG. 3. shows the same illumination system 8 as shown in FIG. 2. FIG. 3, however, shows a situation with a high voltage (typically 10-15 V, depending on the type of liquid crystals) applied between the first electrode 40 and the second electrode 44 by the voltage generator 46. At such a high voltage, the liquid crystals of the birefringent layer 36 are mainly orientated such that their respective longitudinal axes are aligned parallel to the direction of the grooves 34. With such an orientation of the liquid crystals, the extraordinary refractive index of the birefringent layer is much higher than its ordinary refractive index. Again the beam 20 of light is split up into the beam 21 of s-polarized light (i.e. the plane of the light wave is coincident with the plane of the paper) and the beam 26 of p-polarized light (i.e. the plane of the light wave is perpendicular to the plane of the paper) by the grooves 34 filled with birefringent material. As is shown in FIG. 3, the beam 21 (s-polarized light) is coupled out at a great angle α2 to the beam 26 (p-polarized light) and almost normal to the exit face 16. This is due to the fact that the extraordinary refractive index of the birefringent layer is much higher than the ordinary refractive index. The beam 21 leaves the illumination system 8 at almost right angles to the surface 32 and enters the display panel 2.

Thus it is possible to adjust the direction of the light coupled out from the illumination system 8 towards the display panel 2 such that more off-glare angles are obtained, which makes it easier for a viewer observing the display device 1 to observe the information provided thereon.

The application voltages ranging between the voltage represented in FIG. 2 and the voltage represented in FIG. 3 render possible a further control of the angle of the light coupled out.

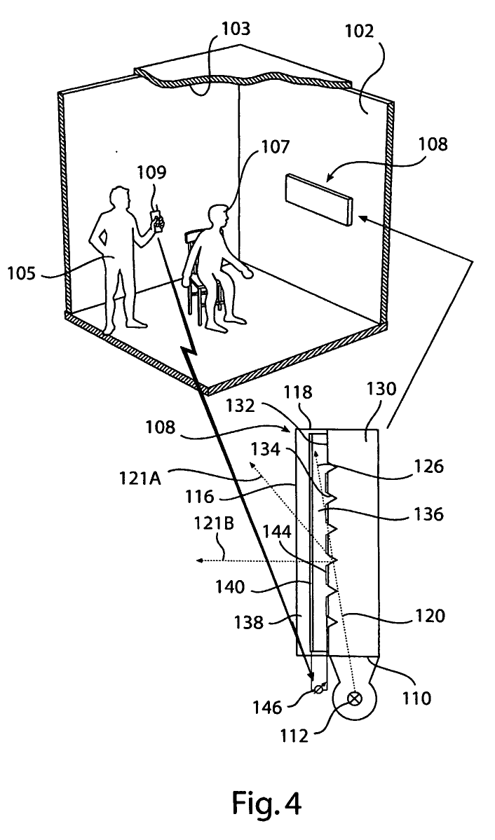

FIG. 4 indicates another application of the invention. An illumination system 108 for room lighting is similar to that described above with reference to FIG. 2. The illumination system 108 shown in FIG. 4 thus comprises an optical waveguide 118 having a flat light guide 130 which is a rectangular parallelepiped made from a material having good optical properties, such as PMMA (polymethyl methacrylate). The dimensions of the light guide 130 are adapted to fit the actual application but could, as a typical example, be 1 m by 1 m with a thickness of 10 mm for room lighting. The light guide 130 has a surface 132 which faces the interior of an examination room 102. The surface 132 is provided with triangular grooves 134 that extend in a direction parallel to an end face 110 at which light is coupled in from a light source in the form of a lamp 112 supplying unpolarized light. A birefringent layer 136 comprising liquid crystals is applied on that surface 132 of the light guide 130 which faces the room 102. A transparent cover glass 138 is applied on the light guide 130 to keep the liquid birefringent layer 136 in place on the surface 132. First and second electrodes 140, 144 having contact with the birefringent layer 136 are connected to a voltage generator 146. The voltage supplied by the voltage generator 146 is controlled by a person, e.g. a nurse 105 examining a patient 107 in the room 102. The voltage generator 146 may, for example, be controlled by a switch or a handheld remote control 109. When a diffuse light is desired, a low voltage is applied to the electrodes 140, 144. A beam 121A of polarized light will then be coupled out at a great angle to the normal of an exit face 116 of the cover glass 138, i.e. towards the roof 103 of the room 102. When a concentrated, directed light is desired, e.g. a direct light on the patient 107 being examined by the nurse 105, a high voltage is applied to the electrodes 140, 144. A beam 121B of polarized light will then be coupled out almost perpendicularly to the exit face 116, e.g. directly towards the patient 107. In both cases light of the undesired polarization (beam 126) is reflected and recycled inside the light guide 130.

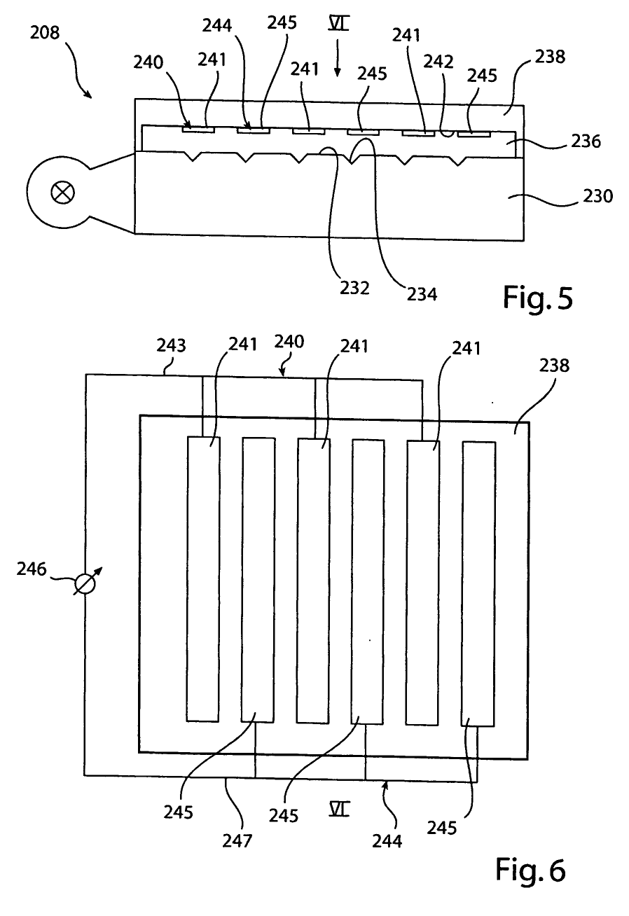

FIG. 5 is a sectional view of an alternative embodiment of the invention. An illumination system 208 shown in FIG. 5 differs from the illumination system 8 shown in FIG. 2 only with respect to the design of the electrodes and the cover plate. A cover glass 238 is applied on a light guide 230 to keep a birefringent material 236 comprising liquid crystals in place. A first electrode 240 comprising a number of elongated stripes 241 is attached to that surface 242 of the cover glass 238 that faces the birefringent layer 236. A second electrode 244 comprising a number of elongated stripes 245 is also attached to the surface 242 of the cover glass 238 which faces the birefringent layer 236 and in such a way that the stripes 245 are located between the stripes 241 and are electrically isolated from them.

FIG. 6 is a plan view of the cover glass 238 taken in the direction of the arrow VI in FIG. 5. As can be seen, the stripes 241 of the first electrode 240 are connected to a voltage generator 246 via a common wire 243. Similarly, the stripes 245 of the second electrode 244 are connected to the voltage generator 246 via a common wire 247. The arrangement of the electrodes 240, 244 may be referred to as an “in-plane switching” since both electrodes 240, 244 that are used for controlling the coupling-out of the polarized light are located in the same plane, i.e. on the surface 242. Due to this arrangement no electrodes need to be located on that surface 232 of the light guide 230 on which grooves 234 are formed.

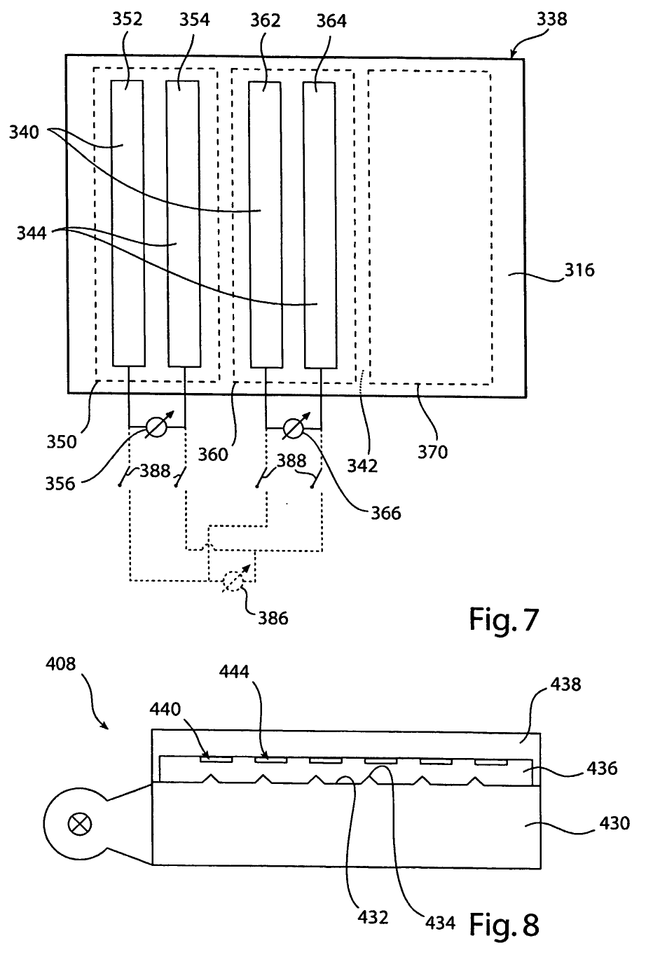

FIG. 7 shows still another embodiment of the invention. FIG. 7 shows a cover glass 338 in a plan view. This cover glass 338 is intended for use with a light guide that has the same basic design as the light guide 230 presented in FIG. 5. The cover glass 338 differs, however, from the cover glass 238 shown in FIG. 6 the design of the electrodes. That surface 342 of the cover glass 338 that faces the birefringent layer (not shown in FIG. 7) is divided into a first region 350, a second region 360, and a third region 370. The first region 350 has a stripe-shaped first electrode 352 and a stripe-shaped second electrode 354 that are attached to the surface 342. The electrodes 352, 354, which together form a first set of electrodes, are connected to a voltage generator 356. The second region 360 has a stripe-shaped first electrode 362 and a stripe-shaped second electrode 364 that are attached to the surface 342. The electrodes 362, 364, which together form a second set of electrodes, are connected to a voltage generator 366. The third region is not provided with any electrodes. Using the cover glass 338, it is possible to apply a first voltage from the voltage generator 356 and thus to obtain a coupling-out of polarized light in a desired direction from the first region 350 via an exit face 316. A second voltage, which is independent of the first voltage, is applied from the voltage generator 366 to obtain a coupling-out of polarized light from the second region 360 via the exit face 316 in a desired direction independently of the light coupled out from the first region 350. From the third region 370 polarized light is coupled out via the exit face 316 at a small angle, e.g. to achieve a diffuse background lighting regardless of the voltages applied by the voltage generators 356, 366. The cover glass 338 shown in FIG. 7 thus provides a certain amount of polarized light coupled out at a small angle from the third region 370 and the possibility of independently controlling the directions of the light coupled out from the first and second regions 350, 360.

In an alternative embodiment schematically indicated with broken lines in FIG. 7, only one voltage generator 386 and switches 388 are used to connect a desired selection of the mutually electrically insulated electrodes 352, 354, 362, 364 to the voltage generator 386. Thus a certain region 350, 360 may be addressed without the requirement for two or more separate voltage generators 356, 366. The stripe-shaped first electrodes 352, 362 may thus be regarded as mutually electrically insulated stripes forming a virtual first electrode 340, and the stripe-shaped second electrodes 354, 364 may be regarded as mutually electrically insulated stripes forming a virtual second electrode 344.

FIG. 8 is a sectional view of still another alternative embodiment of the invention. An illumination system 408 shown in FIG. 8 differs from the illumination system 208 shown in FIG. 5 only with respect to the design of the light guide. A light guide 430 shown in FIG. 8 is provided on its surface 432 with microstructures for coupling out in the form of ridges 434. The ridges 434 are surrounded by a birefringent layer 436 which is covered by a cover glass 438 that also carries a first electrode 440 and a second electrode 444. The ridges 434 will provide a similar coupling-out of polarized light as the grooves described above.

It will be appreciated that numerous modifications of the embodiments described above are possible within the scope of the appended claims.

The materials presented above are to be considered as examples. For example, the cover glass 38, 138, 238, 338 may, as an alternative to glass, be manufactured from a suitable transparent plastic material. The light guide 30 could be made from some other transparent material, such as a symthetic resin other than PMMA or a glass material. The cover glass and the light guide should both preferably be made from electrically insulating materials to avoid short-circuiting of the electrodes attached thereto. The electrodes may be made of electrically conducting materials that are opaque or even completely impermeable to light as an alternative to transparent materials. Transparent electrodes, and in particular electrodes made of ITO, however, are preferable since they may be placed in the pathway of the light coupled out without reducing the intensity of said light.

The microstructures for coupling out may be grooves, ridges or any other suitable structure and may be symmetrical or non-symmetrical. The size and shape, including the groove or ridge angle, of the grooves or ridges is designed in each specific case to obtain the desired coupling-out of light with the materials present in the light guide, the birefringent layer, and the cover glass, and at the different voltages that are to be applied. The grooves preferably have a triangular shape and should be filled with the birefringent material of the birefringent layer. The nature of the birefringnet material itself also influences the direction of coupling-out and the switching behavior.

As an alternative to the use of one light source 12, it is also possible to use two light sources located at opposite end faces.

The invention may be used for providing a three-dimensional (3D) illumination effect by providing different information to each eye by changing the direction of light coupled out for the respective eye.

The display device 1 shown in FIG. 1 comprises a so-called front lighting illumination system 8, i.e. the illumination system 8 is located between the display panel 2 and the viewer who observes the light emitted via the polarizer 25. It is obvious that the illumination system according to the invention may be used also as a back lighting system, i.e. the display panel is located between the illumination system and the viewer. In a back lighting illumination system, the polarized light from the optical waveguide is directed towards the display panel, which will allow some of the polarized light to pass through and reach the viewer, depending on the status of the pixels. Thus the invention is applicable to the illumination of different types of LCDs (e.g. transflective, reflective, or transmissive) and is not limited to the example given above.

It was described above how the invention is used for display illumination (FIG. 1) and for room lighting (FIG. 4). Another field of application of the invention is that of interior car lighting. In a car, the light coupled out from an illumination system could be controlled to provide direct illumination of e.g. a road map or to provide a diffuse background lighting. The invention may also be used for the headlights of a car. Thus the illumination system could be operated to achieve a coupling-out at an angle almost normal to the exit surface, i.e. headlights on, or a coupling-out at a small angle to the exit surface, i.e. dimmed headlights.

In the above examples, the polarized light coupled out leaves the exit face 16 and directly reaches an object, such as a display panel or a patient. It is, however, also possible to provide a reflective coating at the exit face 16 such that the light coupled out is reflected back through the birefringent layer and ultimately leaves the waveguide via the light guide. This alternative is usually less attractive since the luminous intensity is decreased when the light is forced to pass the light guide and the birefringent layer twice, but it may be of interest in some illumination applications.

In the description above it has been shown that the application of a high voltage results in a coupling-out almost perpendicular to the exit face. This is true for birefringent materials having a positive electrical permittivity. It is, however, also possible to use birefringent materials having a negative permittivity, and in such a case coupling-out almost perpendicular to the exit face is instead achieved by the application of a low voltage, a high voltage resulting in the coupling-out of light at a great angle to the normal of the exit face.

To summarize, an illumination system 8 comprises an optical waveguide 18 which is made from optically transparent components and has four end faces 10, 10′. A light source 12 whose light is coupled into the optical waveguide 18 via one of the end faces 10 is situated opposite this end face 10. The optical waveguide 18 has a light guide 30. A birefringent layer 36 comprising liquid crystals is provided on the light guide 30 at an exit surface side thereof. A first electrode 40 and a second electrode 44 both have electrical contact with the birefringent layer 36 and are connected to a voltage generator 46. By varying the voltage applied between the electrodes 40, 44, the birefringent properties of the birefringent layer 36 comprising the liquid crystals may be varied to control the direction of light coupled out via the exit surface 16.

1. An illumination system comprising an optical waveguide (18) that is optically transparent and has an exit surface (16) and a plurality of end faces (10, 10′), opposite to at least one (10) of which a light source (12) is situated whose light is to be coupled into the optical waveguide (18) at said at least one end face (10), the optical waveguide (18) having polarizing means (30, 36, 40, 44) integrated therein for polarizing the light emitted by the light source (12), characterized in that the polarizing means (30, 36, 40, 44) comprises:
a light guide (30) which is made of an optically transparent material and is adapted to receive said light coupled into the optical waveguide (18) at said at least one end face (10),
a birefringent layer (36) comprising liquid crystals provided on the light guide (30) at the exit surface (16) side thereof, and
a first electrode (40) and a second electrode (44) both having electrical contact with the birefringent layer (36) and being adapted to be connected to a voltage generator (46) by which the voltage applied between the electrodes (40, 44) and thereby the birefringent properties of the birefringent layer (36) comprising the liquid crystals may be varied so as to control the direction of light coupled out via the exit surface (16).

2. An illumination system according to claim 1, wherein the light guide (30) comprises microstructures (34, 434) provided at its interface with the birefringent layer (36).

3. An illumination system according to claim 2, wherein the microstructures are chosen from grooves (34), the birefringent layer (36) occupying the space formed by the grooves (34), and ridges (434) surrounded by the birefringent layer (436).

4. An illumination system according to claim 1, wherein a protective cover (38) is provided on the birefringent layer (36).

5. An illumination system according to claim 4, wherein at least one of the first and second electrodes (40, 44) is provided in the cover (38), on a surface (42) thereof that faces the birefringent layer (36).

6. An illumination system according to claim 5, wherein both the first and the second electrode (240, 244) are provided in the cover (238), on the surface (242) thereof that faces the birefringent layer (236).

7. An illumination system according to claim 1, wherein at least one of the first and second electrodes (240, 244) comprises a number of stripes (241, 245).

8. An illumination system according to claim 7, wherein the individual stripes (352, 362, 354, 364) of said at least one of the first and second electrodes (340, 344) are electrically isolated from each other.

9. An illumination system according to claim 1, wherein at least one of the first and second electrodes (40, 44) is made of a transparent conductive material.

10. A method of manufacturing polarizing means (30, 36, 40, 44) in an optical waveguide (18) that is optically transparent and has an exit surface (16) and a plurality of end faces (10, 10′), opposite to at least one (10) of which a light source (12) is adapted to be situated whose light is to be coupled into the optical waveguide (18) at said at least one end face (10), the polarizing means (30, 36, 40, 44) being adapted to polarize the light emitted by the light source (12), characterized by the steps of:
forming a light guide (30) of an optically transparent material for receiving said light coupled into the optical waveguide (18) at said at least one end face (10),
forming a birefringent layer (36) comprising liquid crystals on the light guide (30) at the exit surface (16) side thereof, and
connecting a first electrode (40) and a second electrode (44) to the birefringent layer (36) comprising the liquid crystals for controlling the direction of polarized light coupled out via the exit surface (16) by the polarizing means (30, 36, 40, 44).

11. A method according to claim 10, wherein a protective cover (38) is formed on the birefringent layer (36), at least one of said first and second electrodes (40, 44) being attached to the cover (38) on a surface (42) thereof that faces the birefringent layer (36).

12. A method of controlling the direction of outcoupling of polarized light from an illumination system (8) comprising an optical waveguide (18) that is optically transparent and has an exit surface (16) and a plurality of end faces (10, 10′), opposite to at least one (10) of which a light source (12) is situated whose light is to be coupled into the optical waveguide (18) at said at least one end face (10), the optical waveguide (18) having polarizing means (30, 36, 40, 44) integrated therein for polarizing the light emitted by the light source (12), characterized by the use of a polarizing means (30, 36, 40, 44) comprising:
a light guide (30), which is made of an optically transparent material and is adapted to receive said light coupled into the optical waveguide (18) at said at least one end face (10),
a birefringent layer (36) comprising liquid crystals provided on the light guide (30) at the exit surface (16) side thereof, and
a first electrode (40) and a second electrode (44) both having electrical contact with the birefringent layer (36), wherein
a voltage is applied between the first and the second electrode (40, 44), which voltage provides the desired direction of the polarized light coupled out via the exit surface (16).

13. A method according to claim 12, further comprising the use of an exit surface (316) that is divided into separate regions (350, 360), each being provided with a dedicated set of first and second electrodes (352, 354, 362, 364), and
the application of an individual voltage for the set of electrodes (352, 354, 362, 364) of each region (350, 360) for providing a desired and individual direction of the light coupled out from that particular region (350, 360).
